(19) United States
(12) Patent Application Publication
(10) Pub. No.: US 2003/0177048 A1
(43) Pub. Date: Sep. 18, 2003

(54) Monitoring system and process for the food service industry

(76) Inventor: Ronald Jacobson, Miami, FL (US)

Correspondence Address: MALLOY & MALLOY, P.A., 2800 S.W. Third Avenue, Historic Coral Way, Miami, FL, 33129, US

(21) Appl. No.: 09/826,428

(22) Filed: Apr. 2, 2001

(51) Int. Cl. G06F 17/60

(52) U.S. Cl. 705/8

(57) ABSTRACT

A system and process for monitoring at least one but preferably a plurality of service outlets of the type commonly existing in the food service industry, comprising utilization of a portable processor assembly at a local site, which incorporates both manual and automatic input facilities, at least one of which is defined by a temperature acquisition module interfaced for direct communication with the processor assembly. A monitoring program is operable by the processor and comprises a task application defining a plurality of user interactive test items requiring the entry of user responses upon their performance of the test items. The test items are determinative of currently existing conditions of a plurality of operational categories which are established based on the required functions of the one or more sites being monitored. Result records are formulated based on the data derived from user response entries and are processed preferably at a central control facility for purposes of establishing evidence, preferably in the form of appropriate documentation, of a pattern of compliance with a predetermined plurality of standards which define acceptable performance parameters of the operational categories.

### BACKGROUND OF THE INVENTION

1. Field of the Invention

This invention relates to a system and an attendant process for monitoring the operational performance of one or more sites, such as food service outlets, to assure a consistent pattern of compliance of the site with government and/or owner derived regulatory standards. A monitoring program is preferably utilized with a portable processor, operable at each site, and comprises specific applications intended to direct a user in the performance of tasks which are determinative of the existing conditions at a given site and their compliance or non-compliance with the predetermined standards.

2. Description of the Related Art

In many countries throughout the world, the food service industry is highly regulated in order to assure the safety and well being of patrons which frequent restaurants and other food service outlets. While it has been the intent and practice of those involved in the food service industry to maintain a uniformity of quality, a consistently high standard of performance in a variety of operational categories has not always been practiced. As a result some 70,000 people in the United States alone annually develop conditions of food poisoning. Many of these incidents are directly attributable to poor quality control standards being practiced by restaurants, as well as other food service outlets.

As used herein, it should be noted that the term “food service outlets” is not intended to be interpreted in a limiting sense as relating only to restaurants and/or fast food establishments of the type operating under international recognized trademarks. To the contrary, food service outlets refers to a variety of different operating facilities which, while including fast food delivery establishments and restaurants, is also meant to include a variety of other privately operated or governmentally sponsored food service outlets. Food service outlets also include cafeterias and other food service facilities in prisons, hospitals, governmental agencies, as well as catering and other food preparatory services associated with the transportation industry.

The United States government has recently established a set of minimum government regulatory standards which affect the food service industry generally and in particular the thousands of food service outlets existing throughout the country. These regulatory standards mandate compliance with a predetermined set of quality control, performance and operational parameters. However of equal importance is the additional requirement to maintain records or data which clearly evidences a consistent pattern of compliance of the various food service outlets over a period of time as well as the ability to provide documentation of such evidence. In addition to the above noted governmentally imposed standards, many of the “franchise outlets” operating under a common network of ownership and trademark recognition are contractually required to implement owner/controller standards which commonly exceed and/or otherwise differ from the standards required by the government.

Nevertheless problems still persist in the food service industry which relate not only to preparation and serving of unsafe food products but also to a lack of acceptable performance in a number of other operational categories. Therefore, monitoring of performance should also include, but not be limited to, the maintenance and cleanliness of the physical facilities, and appliances as well as a variety of other services, which detract from the safe operation of these outlets. Even when there have been significant attempts to comply with all regulatory standards, whether governmental or contractually derived, problems of providing evidence of a consistent pattern of such compliance has been extremely difficult.

One factor associated with the difficulty in establishing a consistently high standard of performance is the inability to effectively monitor operational standards at the literately thousands of food service outlets throughout the country. Commonly practiced monitoring techniques are relatively antiquated due to the recording and maintenance of various performance parameters using paper or hard copy records. Proof of a high quality performance is thereby rendered difficult since evidence of such performance, over a significant length of time, is frequently not possible. In more simplistic terms hard copy records evidencing the maintenance of high performance standards at a large number of food service outlets may be kept, recorded and stored. However, their effective retrieval, utilization and production when required may be almost impossible.

Therefore there is a long recognized and significantly important need in the food service industry for a monitoring system and attendant process which assures that existing conditions in any of a large number of operational categories are continuously and consistently maintained. In addition, such an improved system and process should be sufficiently versatile to require and direct specific correctional actions to be taken in the event that certain existing conditions are below acceptable performance standards. In addition, such an improved system should incorporate a process which is sufficiently versatile to easily provide for the change, addition or deletion of any number of operational categories being monitored. The improved monitoring system should be specifically adaptable to the operational and physical facilities of a single outlet or a large number of outlets, such as franchised food outlets, operating under common guidelines.

Finally, a preferred and improved monitoring system and process should be capable of quickly and efficiently producing “result records” which may be entered, stored and otherwise processed in a manner which facilitates their availability in evidencing a consistent pattern of compliance over a predetermined length of time. Also, such evidence should be readily available in hard copy or document form in order to fully comply with the requirements of either government or owner derived regulatory standards.

### SUMMARY OF THE INVENTION

The present invention is directed to a system and an associated process for monitoring the operation and performance of at least one, but more practically, a plurality of sites or outlets which are involved in the food service industry. More importantly the actual conditions which exist at a given site can be reviewed on a timely basis to ensure that the performance of the site is being continuously maintained in accordance with certain predetermined standards. The food service industry, being a highly regulated area of commerce, is subject to regulatory requirements derived by the federal and/or local government. In addition a plurality of outlets such as, but not limited to “franchise food” operations may be contractually obligated to operate under performance and operational standards determined by the “owner/operator” of the franchise company. Further, in the event that a food service site has one or more operational categories which do not comply with the predetermined standards, the monitoring system and process of the present invention expeditiously determine such non-compliance and offer or require corrective actions to be taken by authorized personnel when applicable.

Another important feature of a preferred embodiment of the system and process of the present invention is the ability to collect and store data. This in turn provides, over substantially any period of time, clear and convincing evidence that a pattern of compliance has been maintained with each of the one or more food service sites being monitored. The importance of this capability is based on the federal government's mandate of requiring documented proof of a consistent pattern of compliance with pre-set standards over a period of time. Customers can thereby rely on a consistent level of quality in the food being served, as well as the overall performance and operation of the site which is visited.

Accordingly, one preferred embodiment of the system and process of the present invention incorporates the utilization of a processor assembly intended to be operable at each of the sites being monitored. Preferably, the local processor assembly is portable and may comprise the handheld, personal digital assistant (PDA) hardware. Such devices incorporate a significant amount of memory, a visual display in the form of a display screen and may be adapted or modified to include a plurality of different input facilities.

The input facilities allow the personnel or “user” to enter required or requested “user responses” either manually or automatically. In the latter category the required user response may be in the form of a specific numerical value, such as the temperature of the food being cooked and/or the plurality of appliances used in the preparation and storing of the food being presented. As will be explained in greater detail hereinafter, a temperature acquisition module or “TAM” is interfaced to communicate directly with the local processor assembly. The TAM may include a variety of different structures, such as temperature sensing probe assembly of the type manufactured and made commercially available by ATKINS TECHNICAL, Inc.

Another important feature of the preferred embodiment of the monitoring system and process of the present invention is the development and incorporation of a monitoring program specifically designed to facilitate the expeditious review of the operation of each of one or more food service sites. More specifically, the monitoring program facilitates the detailed review of a plurality of “operational categories” which have been predetermined by the owner or by any other authorizing entity. The operational categories should be sufficiently comprehensive to comply with all of the government and/or owner derived regulatory standards under which the food service site is required to operate. Moreover, the monitoring program is designed to include a plurality of program applications which collectively allow for the expedient monitoring of the quality control and performance of the operational categories involved in the everyday functioning of the one or more food service sites.

One such program application is herein referred to as a task application and comprises at least one but more typically a plurality of user interactive “test items”. The plurality of test items are designed to review, in significant detail, each of the procedures associated with each of the operational categories which are included within the overall monitoring procedure. Further, each of the test items, as performed and/or reviewed by the user, requires a user response which is indicative of the actual conditions associated with the specific test item being reviewed. The resulting user responses are by virtue of the operation of the monitoring program, compared with the predetermined standards, also incorporated into the program. The user may thereby instantly determine whether or not the test item being reviewed is within acceptable performance parameters of the aforementioned predetermined standards.

Another feature of at least one preferred embodiment of the present invention comprises the inclusion of a corrective application in the monitoring program. The corrective program application provides for the immediate communication to the user of one or more corrective actions which should be undertaken, if applicable, to bring the one or more existing conditions associated with the individual test items back into compliance with the acceptable performance parameters as defined by the predetermined standards.

A plurality of other program applications are also incorporated into the monitoring program. These cooperatively designed applications further serve to maintain the operation and performance of the one or more food service sites in compliance with the predetermined standards on a consistent basis. Such additional program applications include scheduling and/or timing applications which indicate or provide a periodic schedule when the various user interactive tasks should be performed. In certain instances it will be preferable for the user to perform the indicated test items in a predetermined sequence. Directly associated therewith is the provision of an alert application. An alert or signal is thereby provided through the workings of the local processor indicating to the user or other responsible personnel that performance of scheduled tasks has been missed or is late or is performed out of sequence.

In order to assure that the predetermined standards under which the food service industry operates are met, another important feature of the system and attendant process of the present invention is the establishment of “result records”. The result records are comprised of data derived from a collection, storage and processing of the various user responses provided by responsible personnel at the one or more food service site. As such, the user responses are clearly indicative of existing conditions at the one more sites being in compliance with the predetermined standards. Compliance is assured by virtue of the fact that any test item found to be outside of the acceptable performance parameters, as determined by the aforementioned predetermined standards, is brought back into compliance by the user following the aforementioned corrective actions.

Accordingly, the result records, after being collected are initially stored in the local, portable processor assembly or PDA and eventually transmitted to a control facility. The control facility may represent the owner's head quarters, operational center, data processing center, etc. In addition, the control center further comprises the provision of a central processor having sufficient capabilities to store and process the result records received from each of the one or more food service sites. The processing of all of the result records are accomplished in a manner which clearly evidences a pattern of compliance with the predetermined standards.

Therefore, the monitoring system and process of the present invention will allow a user to run scheduled and unscheduled procedures relating to specific operating categories. These monitoring procedures comprise multiple user interactive test items. Some or all of the test items require a user response indicative of compliance or non-compliance with predetermined standards, which are derived from the government, food service industry or the owner/controller of the food service sites being monitored. The user responses are recorded, and processed to provide evidence that the predetermined standards, such as those originating with the Food and Drug Administration and include it the Hazard Analysis and Critical Control Point (HACCP) guidelines, are in fact met. Implementation of the system and process of the present invention is based, to a significant extent, on the design and utilization of the monitoring program installed in each of the plurality of locally operable processor assemblies by a host computer or PC also located at each of the individual food service sites being monitored.

More specifically, the user will initially prepare the system, including the monitoring program by syncing it with a host computer to download a plurality of operational categories along with a test application included as part of the program. The test application is comprised of a plurality of user interactive test items representing individual procedures to be performed in order to assure compliance with the aforementioned predetermined standards. All user responses will initially reside in the database of the local, preferably portable processor assembly for eventual transfer to the host computer and/or a central control facility to be processed to the extent of providing evidence, which may be in the form of appropriate documentation, of a consistent pattern of compliance of the one or more food service outlets being monitored.

Accordingly, the monitoring system and accompanying process of the present invention provide an efficient and expeditious procedure for assuring that the performance and operational characteristics of anyone of a plurality of food service sites are within the acceptable parameters determined by government and/or owner regulatory requirements, herein referred to as the predetermined standards. Moreover, the system and process of the present invention eliminates the burden of voluminous quantities of hard copy record keeping and are an efficient means of providing evidence, which may be required to be documented, of a consistent pattern of compliance of each or all of one or more food service outlets over any applicable period of time. Further, the system and process of the present invention can be implemented at an extremely competitive cost and requires significantly less time for conducting the monitoring procedures than was previously possible using conventional systems. Further, the subject system and process can be implemented without extensive, specialized training of the user personnel.

These and other objects, features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a graphical representation of the food service monitoring system of the present invention.

FIG. 2 is a schematic representation of a downloading procedure between a host computer and a local processor assembly incorporated in the monitoring system and process of the present invention.

FIG. 3 is a flow chart in block diagram form which is descriptive of the monitoring process associated with the preferred embodiment of the system of the present invention as disclosed in FIG. 1.

FIGS. 4 through 15 are schematic representations of computer windows displayed on the local processor assembly associated with each food service site, wherein the various window displays demonstrate the procedural and operational applications incorporated in a monitoring program downloaded into each of the one or more local processor assemblies.

Like reference numerals refer to like parts throughout the several views of the drawings.

### DETAILED DESCRIPTION OF THE PREFERRED EMBODIMENT

As shown in the accompanying Figures, the present invention is directed towards a system and associated process for monitoring at least one but preferably a plurality of food service sites for purposes of assuring that each of the sites is operating in accordance with predetermined standards. The predetermined standards may be mandated by the federal or local government, may be accepted as industry wide standards or may be derived from a contractual obligation of the one or more food service site. Further, the system and method of the present invention is capable of obtaining, storing and processing result records which may be used as evidence of a consistent pattern of compliance with the applicable predetermined standards under which the various food service sites are required to operate.

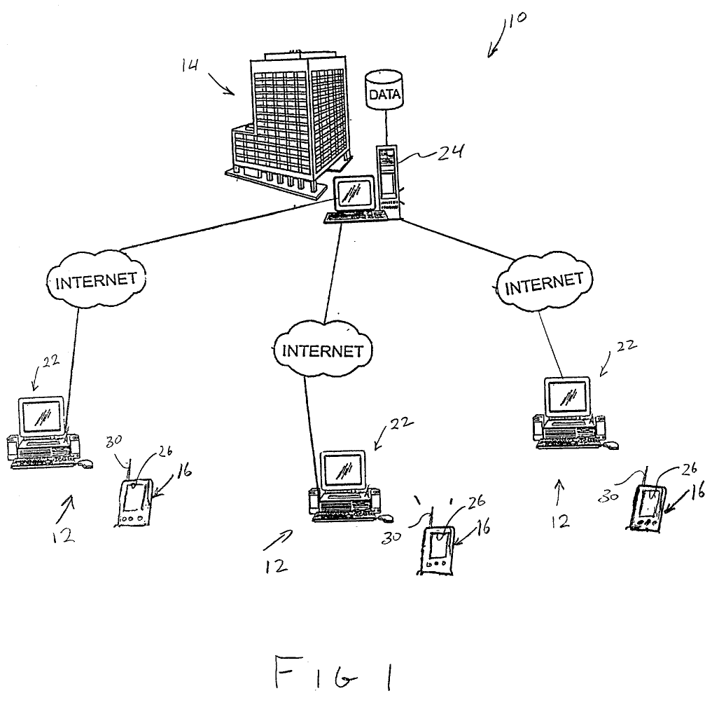

A schematic representation of the system of the present invention is generally indicated as 10 in FIG. 1 and for purposes of clarity comprises at least one but preferably a plurality of sites each indicated as 12 owned, operated or functioning under the auspices of an owner/controller, generally indicated as 14. Accordingly, the schematic representation of FIG. 1 represents at least one preferred embodiment of the system and process of the present invention, wherein the owner/controller 14 may be the franchise holder operating under a family of trademarks through a plurality of food service sites 12 located throughout the country or other geographical area.

It is emphasized however that the system and process of the present invention is not limited to “fast food” or the franchise segment of the food service industry. To the contrary, the present invention is applicable for monitoring and maintaining acceptable quality control and performance levels of any type of food service site including those operating in the private sector or other food service sites operated or sponsored by federal or local government. The latter category includes food service facilities associated with prisons, hospitals, schools, etc. and/or the transportation industry.

Accordingly, in one preferred embodiment of the present invention each of the food service sites 12 incorporates the use of a processor assembly generally indicated as 16 and which may be defined as a portable, handheld processor or personal digital assistant (PDA). Applicable hardware to be used could include, but is not intended to be limited to, one or more PDA models, of the type commercially available under the trademark Casio. By way of example only, the Casio Cassiopeia models EG-800 and E-115 are applicable for use as the local operating processor assembly in the implementation of the system of the present invention. Both of these models include a 32MB RAM and color levels of 65,536 color.

Further, processing software involved may be utilized and developed by any of a variety of software designers and the main executable application can include any dynamic-link library (DLL), which is a feature of the Microsoft Windows® family of operating systems. Each of the local processor assemblies 16 will be downloaded with a monitoring program 20 which represents another feature in the implementation of the system and method of the present invention. As will be explained in greater detail hereinafter the monitoring program 20 includes a plurality of specifically designed applications to facilitate the review and maintenance of various performance and operational parameters conducted by each of the fast food sites on a daily or other periodic basis.

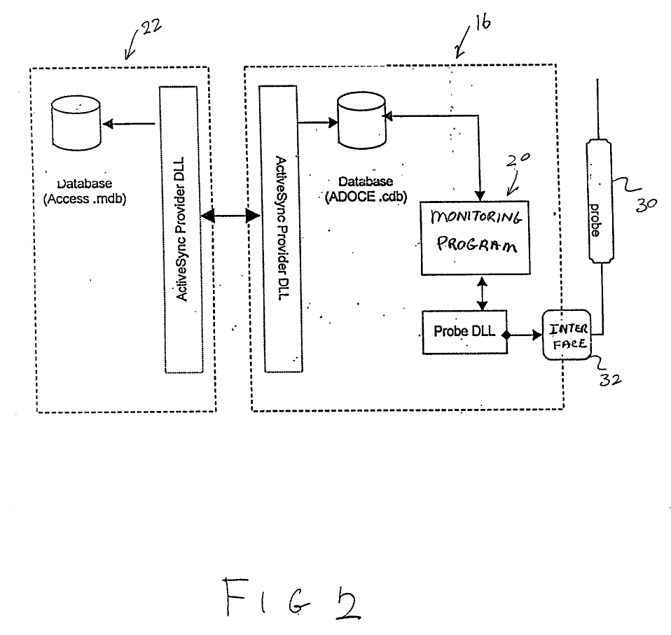

With reference to FIGS. 1 and 2, downloading of the monitoring program 20 is schematically represented as 20 and may be accomplished by means of a host computer 22, also located at each of the plurality of food service sites 12. Accordingly, a system may comprise as processing components, the use of the local processor assembly 16 and the host computer 22, which may be in the form of a conventional desk top PC. Applicable collected or stored data can eventually be transferred to a central control facility 14, which may be in the form of a processing center 24 associated with the owner/controller. Communication between the plurality of sites 12 and the control facility 24 can be by means of the Internet, which will also be explained in greater detail hereinafter. It is also important to note that each of the processor assemblies 16 contain a display in the form of a visually observable display screen 26.

In addition, each assembly includes sufficient memory and/or database storage facilities as indicated in FIG. 2 and at least one but preferably a plurality of input facilities. The input facilities may include a manual entry in the form of a touch sensitive keypad communicated to the user on the display screen 26 and operable by effective “finger-tap” response. In certain instances the finger-tap response may be more convenient than using probe or stylus application for manual entry. In addition, on some portable processors, a calculator function is typically available with near/full screen spread of 5×5 buttons which may be sufficient to utilize adequate finger-tap response.

In addition to the manual entry, as set forth above, the input facilities of the processor assembly 16 may comprise automatic entry capabilities in the form of a temperature acquisition module or “TAM”. The TAM preferably comprises a probe assembly 30 which is interfaced, as at 32, for direct communication with the processor 16 and the monitoring program 20. The probe assembly 30 preferably comprises a temperature sensing probe structure of the type manufactured and made commercially available by ATKINS TECHNICAL, Inc. Through its use, specific numerical data (temperature) will be determined and communicated to the processor assembly 16 and thereby define the “user response”, which will be evident on display 26.

It should be noted that while the plurality of input facilities, as set forth above, are available to the user in conducting the monitoring process, additional manual entry may be utilized. For example, when the user determines an existing temperature or other condition by reading appropriate output associated with a stove, refrigerator or other appliance, this data may also be manually entered. In such case the automatic input facility in the form of the TAM may not be needed and the user has the capability of manually entering the determined temperature, representative of the appropriate user response, in the manner set forth above.

Another important feature of the present invention is the inclusion of the above noted monitoring program 20 which serves to implement the system and process of the present invention. The monitoring program 20 includes a plurality of program applications which are designed to determine whether or not the performance characteristics of specific operational categories meet the required parameters, as defined by the predetermined government, industry and/or owner standards. The aforementioned “operational categories” refer to the physical facilities, and food products as well as the procedures utilized and performed on a daily or other periodic basis in the normal functioning of a food service site.

By way of example, and as described in greater detail hereinafter, such operational categories may include physical facilities such as the kitchen, dining area, bathrooms, storage areas, drive-thru facilities, etc. Additional physical facilities included in the aforementioned operational categories may include the various appliances, their cleanliness, operating conditions, etc. A specific operational category of concern would also be the food as it is stored, prepared and served along with the utensils, appliances and other equipment related to such service. It is also emphasized that the various examples of the operating categories set forth herein are not meant to be interpreted in a limiting sense. In particular, the operational categories may be varied to include any number of physical facilities or procedures that need be reviewed or monitored on an individual or periodic basis. Compliance with the predetermined standards of operation under which the one or more food service sites are required to operate is thereby further assured. Also, the monitoring program can be modified to the extent of effectively adding, deleting or customizing the operational categories and/or test items, corrective actions, etc. associated therewith so as to more effectively perform the required monitoring procedures at a given food service site.

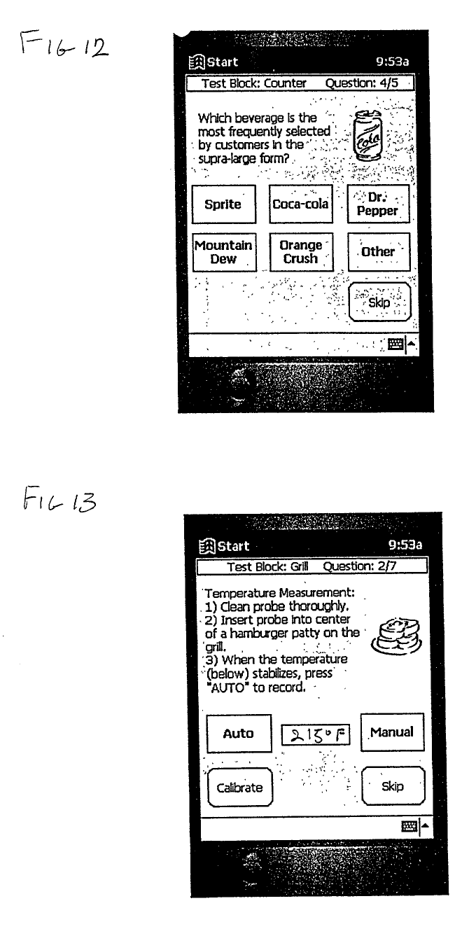

Therefore, as described in greater detail with specific reference to FIGS. 3 through 15, the monitoring program 20, serves to significantly implement the system and process of the present invention. Accordingly, the monitoring program includes a task application comprising a plurality of tasks each relating to one or more of the aforementioned operational categories. Each of the tasks comprise at least one but more typically, a plurality of user interactive test items requiring some type of act or performance of the user. The test items and acts of the user are designed to determine whether or not the various physical facilities, appliances, etc. as well as the procedures used in the functioning of the food service site, meet the aforementioned performance parameters mandated by the predetermined standards.

The various test items may be considered the most dynamic components of the monitoring program in that they will normally require the user to provide one or more specific “user responses”. The user response provides a direct indication as to the actual or existing conditions of the food service site being monitored, as well as indicating that the user has attended to the particular task associated with a given test item. The user response will be entered into the memory capabilities of the local processor assembly 16 and at least initially stored therein for eventual transfer and future processing.

The user responses will be collected and result in the establishment of the result records which are eventually transferred for processing to the process center or central control facility 24 of the owner/controller 14. More specifically, the result records are derived from data entries of the user responses which have been entered into the date base of the individual processor assemblies 16 by means of the plurality of input facilities as set forth above. In addition, the result records are also derived from data which may be obtained by the user performing an indicated corrective action in the event that the existing condition of the test items being monitored are non-compliant with the parameters of the predetermined standard.

The corrective actions may be defined as an additional corrective application of the monitoring program and are evident to the user on the display 26 of the corresponding processor assembly 16. The corrective actions may vary in number and further suggest tasks that may require a supplementary user response. The supplementary user response is made in order to verify that the corrective action and/or the task associated therewith has in fact been performed. As will be further evident the receipt or input of a user response which is non-compliant may result in a plurality of corrective actions being suggested. The user therefore decides which of the suggested or required corrective actions is best applicable for the situation. The ultimate goal in the issuing and performance of a corrective action is the correcting of the existing conditions being monitored so as to eventually conform to the operational or performance parameters defined by the predetermined standards.

Another important feature of the present invention is the ability of the monitoring program 20 to recognize existing conditions which may be technically in compliance with government standards or other regulatory requirements under which a food service site operates. More specifically, in one preferred embodiment of the present invention the owner/controller standards are designed and structured to establish existing conditions which are unacceptable even though they meet or are in compliance with the government standards. By way of example only, existing standards mandate that the minimum internal temperature for a cooked hamburger is 157 degrees Fahrenheit in order to be safe for consumption. However, because separate conditions may exist, attributable either to a failure of the personnel at a given food service site or to a malfunctioning of the cooking appliance, the user may determine that the actual temperature of the hamburger is well in excess of the minimum 157 degrees Fahrenheit. Therefore, while the “overcooked” hamburger may very well comply with the government standards, as a practical matter it is unacceptable for presentation to the consuming public.

Accordingly, the predetermined standards incorporated within the subject monitoring system and process also include owner/controller standards which “exceed” the government standards by recognizing existing conditions which meet government standards but are unacceptable because of practical or other operational considerations. In addition, depending upon the particular operational category or test items under review, specific corrective actions may or may not be issued to the user under such conditions. It is also to be noted that the owner/controller standards which go beyond the minimum government standards, in the manner generally set forth above, can relate to a variety of different operational categories and are not limited exclusively to the quality control of food.

The monitoring program further comprises additional applications including a scheduling/timing application. Each application is designed to assure that all of the operational categories are in fact monitored. Assurance of user performance of all the required test items may therefore best be accomplished by scheduling performance or review of the test items on a regular, periodic basis and at specific times. By way of example only, cleanliness conditions and adequate supplies of the bathroom may be scheduled to be conducted periodically throughout the business day.

Cooperatively, the monitoring program may also include an alert application which notifies the user if an operational category and/or any of the tasks associated therewith, including the individualized test items, have not been conducted or have not been conducted in timely fashion in accordance with the scheduling/timing application as set forth above. Further and also by way of example, the user will be notified and the result records will indicate if certain operational categories, required tasks and detailed test items are consistently deleted from the daily monitoring procedure or are otherwise consistently or periodically late in their performance. Communication of the alert application to the user or other authorized personnel may be by means of a visual display on the display 26 of the corresponding local processor assembly 16 or by any other visual or audible indication which may be a somewhat conventional part of the PDA or other type of portable processor assembly 16.

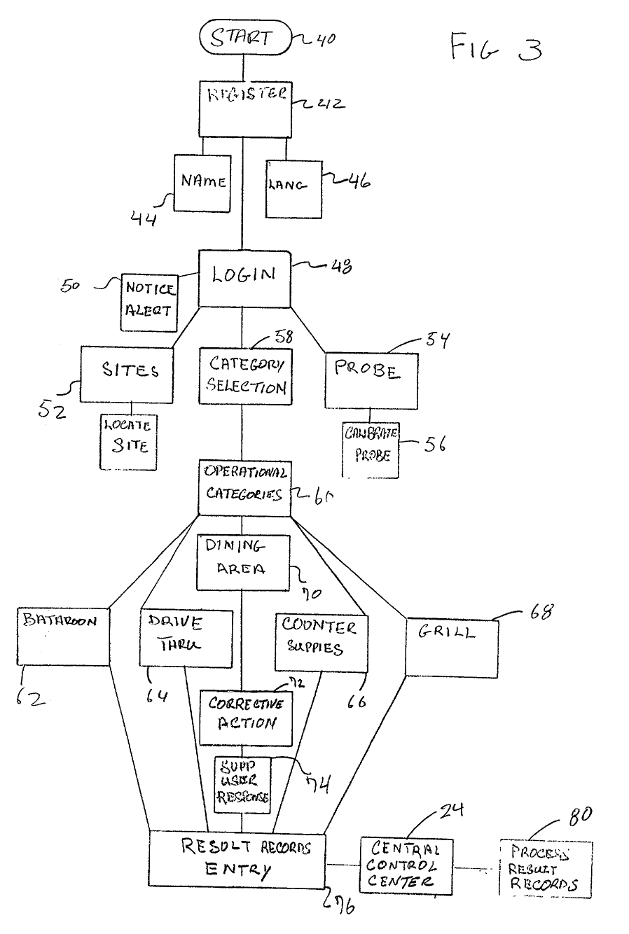

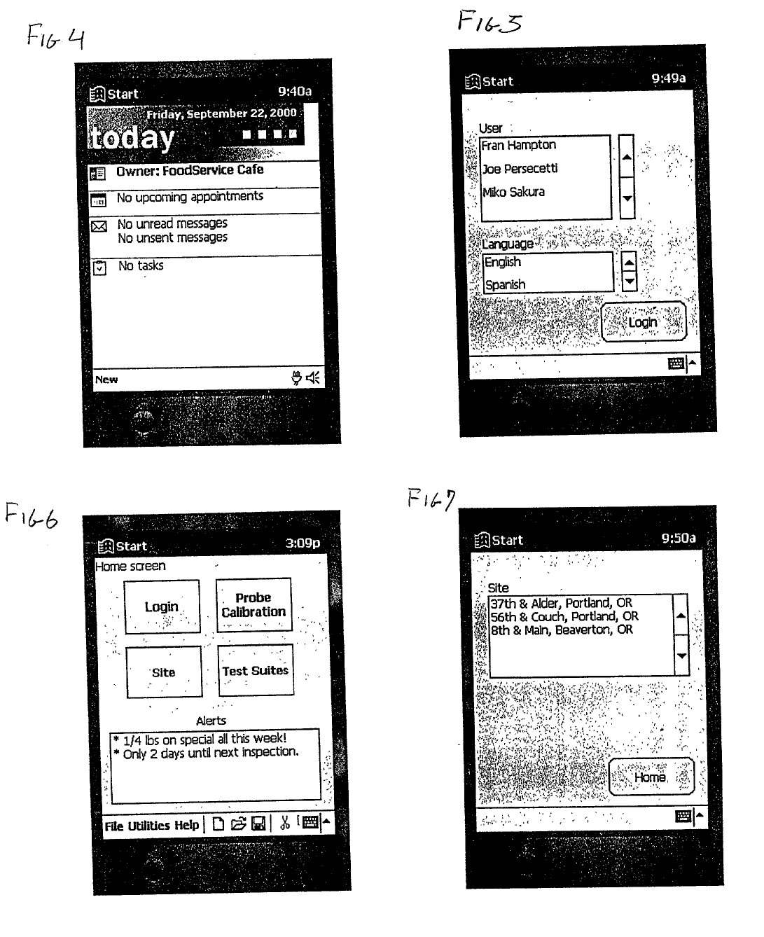

With reference to FIGS. 3 through 15, the system and accompanying process will be activated by appropriate start procedures 40 utilizing conventional hardware activation components associated with the PDA or local, portable processor assembly 16. When started the display 26 of the processor 16 will be occupied, as indicated in FIG. 4, so as to initially present the basic identifying characteristics in terms of proprietor, notices, messages, pending duties or tasks. During installation, activation of the monitoring program 20 can be activated using a manual hot key of the processor assembly 16. The monitoring program 20 is allowed to start with a single finger-tap, response rather than utilizing the stylist associated with the PDA to navigate through the various applications of the monitoring program.

As represented in FIGS. 4 through 15 each of the displays can be full screen in order to provide a clear visual communication as well as additional space for the manual entry of finger-tap contact of any user response buttons or the electronically displayed keypad. In addition and as part of the input facilities, a user may be requested to provide numeric input, other than through the automatic entry associated with the probe assembly 30. In such an event a button may be available through on-screen display that will activate a pop-up or drop down menu for additional data entry. As with all of the user response entries or other entry of numerical or specific data, the display keypad will be large enough to accommodate finger-tap response and will comprise a common numeric keypad display. In addition “clear” and “entry” keys associated with the processor assembly 16 may be used.

With reference to FIG. 3, the system and process next involves a registering or acknowledgment of the user, as at 42. As such, the window of FIG. 5 will occupy the display 26 allowing the user to accomplish personal identification as at 44 as well as selecting a preferred language as at 46. A user list may be stored in the data base of the processor 16 and each of the user's identifying name or other identification source may be associated with a preferred language rather than requiring the user to select a language each time he or she registers.

A login key will be provided in the identifying window of FIG. 5 and when activated by finger-tap response, a home or login screen, as demonstrated in FIG. 6, will occupy the display 26 of the corresponding processor assembly 16 and indicated as 48 in FIG. 3. The home or login screen will display various informative data including personnel present on an existing shift, probe calibration condition and site designation. In addition, alert notices as at 50 may be provided to indicate to the user or other personnel various messages relevant to the daily or routine operation of the food service site or a variety of other conditions, which currently exist or which may require attention in the future. More specifically, activation of the site indicator as at 52 will cause display of the various food service site and/or their location such as when a plurality of food service site 12 are operating under an identical monitoring program and are otherwise networked into a common field of operation.

The site screen or window as represented in FIG. 7 allows the user to choose the specific site at which he/she is operating the monitoring procedures. Naturally, the site screen may not be applicable for a single food service site operation or where there is no operational network involved with a plurality of sites. The user may then activate the home indicator or button and return to the home window of FIG. 6.

When returned to the home window of FIG. 6, activation of probe calibration procedures may be accomplished to ensure that the probe assembly 30 of the TAM is in fact properly calibrated and ready for immediate use. When such occurs and upon a need only basis, the probe calibration window demonstrated in FIG. 8 will be evident on the screen 26, allowing for the user to perform a calibration check. Subsequently, return to the home screen of FIG. 6 occurs to begin the process of performing the various monitoring applications associated with the monitoring program 20.

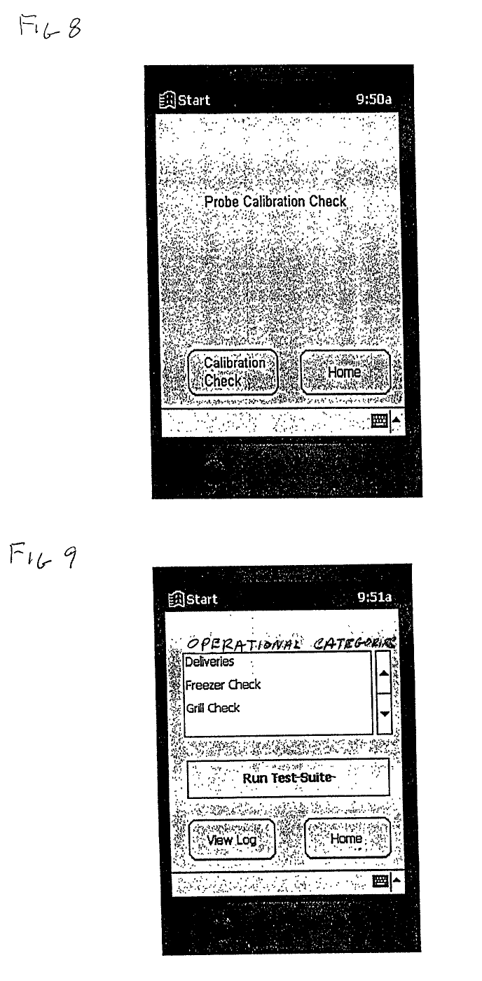

Subsequent to the review and calibration of the probe assembly 30 as at 54 and 56 of FIG. 3, and upon the user returning to the home screen of FIG. 6, the user is ready to select a first operational category or a plurality of operational categories to be sequentially monitored. With reference to FIG. 9 the operational category screen will be evident on display 26 and include a plurality of individual categories such as deliveries, freezer check, grill check, etc. Naturally a much larger number of operational categories will normally be included in conducting the complete monitoring process. However, at any given time of day a lesser number of operational categories may be indicated for performance check or review as indicated. The user reviews the display list of operational categories and chooses individual ones thereof by any type of manual entry such as finger-tap entry.

Once highlighted or indicated the particular operational category, such as “deliveries” will be activated upon the indication button “run test” being touched by the user. As set forth above and as further indicated in FIGS. 9 through 15, the various operational categories 60, in addition to those disclosed in FIG. 9, may include monitoring procedures associated with the bathroom as at 62, drive thru facilities 64, counter supplies and conditions, as at 66, and the grill or other cooking appliances, as at 68. Also, and as explained hereinafter the dining area 70 may also be included as one of the operational categories presented for choice and performance of the pre-established monitoring procedures.

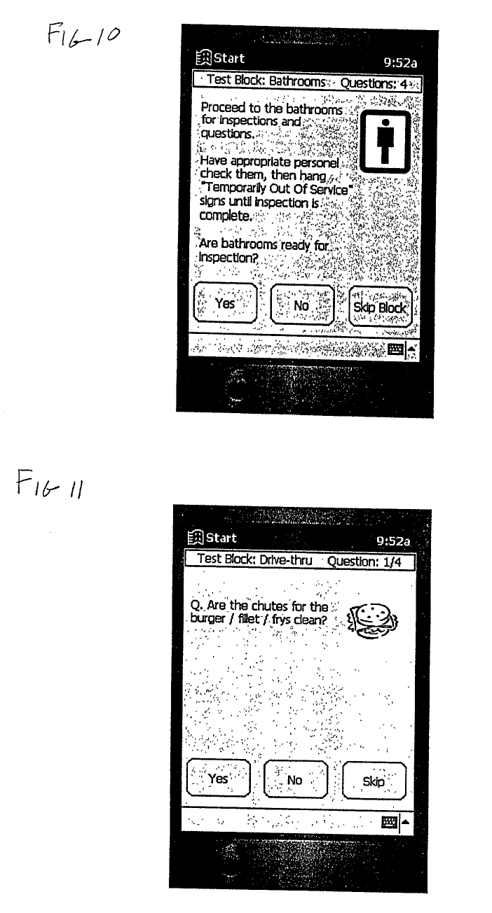

As initially demonstrated in FIGS. 10 and 11 and as set forth above, selection of any of the operational categories 62, 64, 66, 68, 70 etc. results in a “test block” screen being evident on display 26. With specific reference to FIG. 10, the operational category being monitored is indicated as bathrooms and the task application defining an operative portion of the monitoring program will present to the user a plurality of test items. The test items may be in the form of declaratory or instructive type statements and/or in the form of test questions. In either form the test item will normally require interactive performance by the user to make sure that all the monitoring procedures are followed thereby determining the state of the actual or existing conditions relating to each of the operational categories being monitored.

By way of example, and with continuing reference to FIG. 10 the user, following the test item instructions, will proceed to the bathroom for inspection. Determination if appropriate personnel has previously checked the bathrooms for various conditions such as cleanliness, supplies, etc. will be made as well as whether the “out of service” sign has been displayed until any inspection is complete. The user may further proceed with other actions such as determining if in fact the bathrooms are ready for inspection, whether they are occupied or unoccupied, etc. It is again emphasized that most if not all, of the indicated test items will require a user response. The user response can be in the simplified form of a “yes” or “no” answer as provided by the appropriate indicator button. As set forth above, manual entry may be in the form of a finger-tap entry to provide the large user response.

With regard to FIG. 3 other operational categories, such as the condition of the grill 68 or performance at a drive thru facility 66, represents other operational categories. As such, the test block screen relating to drive thru facilities (FIG. 11) will occupy the display 26 and communicate the appropriate test items, such as “Are the chutes ready for the burger/filet/fries clean?” Again the user response is manually entered through a finger-tap response. As set forth in FIG. 3 the various additional operational categories 62-68, etc. are sequentially reviewed indicating specific test items relating to the operational category under review. It is again emphasized that dependent at least in part on the context of each of the test items presented, some actions or performance will be required by the user. Further, a user response at least in form of acknowledgment such as “yes” or “no” will be requested of the user to indicate that the user's attention is directed to a particular test item. Of course a user response indicating actual or existing conditions of the items or facilities under review maybe requested also.

With regard to FIG. 13 a review of the operational category involved with the grill, cooking appliances and proper heating or cooking of the various food products is demonstrated by the appropriate window in the display 26. As such, the probe assembly 30 may be utilized to automatically determine and define each of the user responses. By way of example, the user is directed to clean the probe, and insert the probe into the center of the hamburger (or other food product) currently being prepared. The result will be an automatic user response read out in the form of a specific temperature. Further directional information or directive test items are presented to the user to assure that the probe assembly 30 is properly utilized. Once the probe structure associated with assembly 30 is properly inserted and stabilized, as required, the “auto” indication can be activated resulting in the user response being defined as a numerical data, such as 160 degrees Fahrenheit. Alternatively, the cooking temperature of the grill may be readily available by reading appropriate metering devices associated with the grill in conventional fashion. Utilization of the probe TAM comprising assembly 30 and in particular the temperature sensing probe associated therewith, is not required under such circumstances.

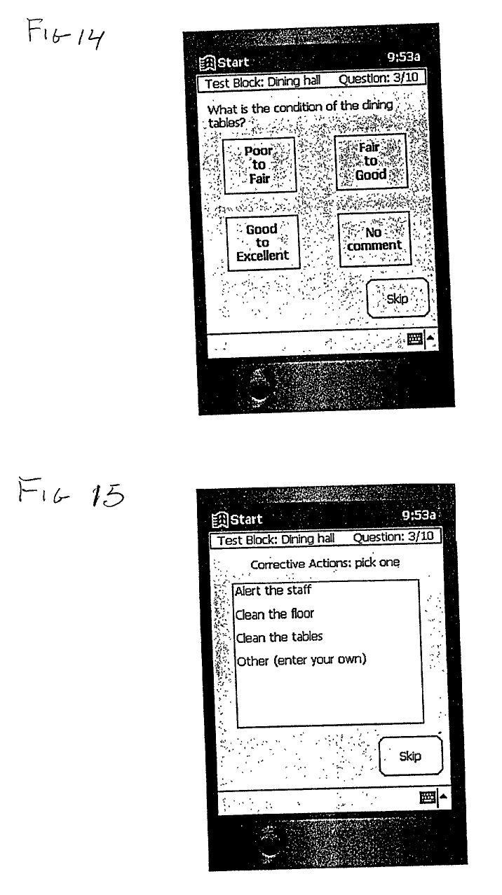

It is recognized that in the course of conducting the monitoring procedures of the system and process of the present invention, operating performance, quality control and currently existing conditions will be discovered that are not in compliance with the performance parameters as defined by the predetermined standards. In such situations the monitoring system and process of the present invention assures eventual compliance through the provision of a corrective application associated with the monitoring program 20. With reference to FIGS. 14 and 15, and using as an example the operational category of the dining area 70, the associated task application will present on display 26 the appropriate window shown in FIG. 14. Various test items presented may for example include: “What is the condition of the dining tables?” At least one but normally a plurality of user responses will be concurrently displayed on the test block screen relating to the operational category of dining hall. These user responses will be appropriate to all of the applicable conditions that may exist, such as relating to the dining room tables. If after the user performs an inspection of the tables, they are found to be in good to excellent condition, the appropriate on screen indicator button will be indicated by finger-tap entry or the like. This user response as processed by the monitoring program will be found to be within the acceptable performance parameters that the predetermined standards requires. However, if upon inspection the user provides a “poor to fair” user response the monitoring program will then activate the corrective application resulting in the communication of the window of FIG. 15 on the display 26. The corrective application comprises a plurality of correlated corrective actions to be performed or conducted by the user in order to correct the non-compliant existing conditions which have been discovered. Again by way of example, the plurality of suggested corrective actions include “alert the staff”, “clean the floor”, “clean the tables”, etc. If the user finds that other actions are required, he/she indicates or records what the actions are, such as by manual entry using the or other facilities of the processor 16. The user then performs the corrective action indicated.

It is again emphasized that an important feature of the present invention is the creation of the result records as at 74 so as to provide a full and complete evaluation of the performance parameters of any one or more food service sites 12 being monitored throughout the entire system 10 as demonstrated in FIG. 1. It is also emphasized that the importance of the result records are based on the fact that they are derived from data entries comprised of the plurality of user responses, as well as corrective action performed by the user. Accordingly, it is important that in many instances the corrective action 72 be followed by a supplementary user response 74 (see FIG. 3). The supplementary user response indicates the specific corrective action taken and/or a rechecking as to the new conditions existing subsequent to taking any related corrective action. For example, a review of the temperature at which a hamburger or other food product is being cooked may initially indicate that it is below standards. Adjustment of the appliance, cooking time, etc. representing the corrective actions will hopefully result in all other food products being cooked at the will therefore be an important part of the formulation of the result records along with the various user responses, corrective actions taken and results of the corrective actions, as set forth above.

The result records once formulated and as initially stored in the data base of the processor 16 is eventually communicated to the owner/controller 14 and/or more specifically to the central control facility which, as set forth above, may be represented by a processing center, as at 24 in FIG. 1. Downloading of the result records, and other appropriate data can first be accomplished from the processor 16 to the host computer 22 located at the individual food service site 12. Complete data transfer of the result records and other information could be accomplished by a variety of conventional communication facilities, including the Internet, which establishes an appropriate communication link between the individual host computers 22 and the central control center and associated process center 24. Alternatively, modern technological advancements in the computer sciences, including both hardware and software, can also allow data communication or transfer of the result records directly from the individual processor 16 such as by wireless application protocol (WAP) if the individual PDA or like processor 16 incorporate WAP capabilities.

In any event the result records are transferred to the control center 24 and stored and further processed so as to provide effective evidence of a consistent pattern of compliance with the predetermined standards or other regulatory requirements under which the plurality of food service outlets 12 are required to operate. The processing of the result records further includes making them available in document or hard copy form when required, such as in response to the government derived standards.

In addition to the above, in order to provide clear evidence of a pattern of compliance, the system and process of the present invention and in particular the monitoring program associated therewith incorporates the additional scheduling or timing application. This application first serves to schedule the performance of the various tasks and the individual test items associated therewith. Therefore such tasks are scheduled to be performed a certain number of times during the working day and even at specific times. In addition, in order to assure compliance as well as further verify the reliability in the formulated result records, each of a number of entries, such as user responses manually or automatically entered using the input facilities of the processor assembly 16 are date and time “stamped”. Applied date and time stamping will therefore provide a clear indication as to the time and date, the number of occurrences a given test item was performed, the user response provided and any corrective action and/or supplementary user response needed to bring the actual or existing conditions of a given operational category into clear compliance with the performance parameters defined by the predetermined standards. Also, it may be desirable to schedule certain ones of the user performed tasks, as well as the individualized test items associated therewith in a sequential order of performance for purposes of better utilizing the time of the user or other personnel of the site.

In order to assure performance of the user tasks as defined by the task application of the monitoring program and to provide an even more specific evaluation as to whether or not all of the operational categories are being properly reviewed, the monitoring program incorporates an alert application. The alert application will provide some type of visual and/or audible indication or alert, to the user or other authorized personnel, as to the non-occurrence of a scheduled task or of one or more of the test items. Alternatively, an alert or indication will be provided to the user or other supervisory personnel when one or more of the test items are consistently or periodically performed on an untimely basis in order that the various tasks may be re-scheduled for a different time of day or alternatively the personnel involved in the required task and test item be advised as to the continuous untimely nature of the monitoring procedures being performed.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A system for monitoring a food service site, said system comprising:
a) a local processor assembly comprising memory, a display and input facilities,
b) said local processor assembly including a monitoring program structured to determine operational performance of the site,
c) said monitoring program comprising a plurality of tasks relating to different operational categories, at least some of said plurality of tasks requiring a user response,
d) predetermined standards included within said monitoring program and being determinative of acceptable performance of said operational categories,
e) result records comprised of data derived from a collection of said user responses and indicative of compliance of said operational categories with said predetermined standards, and
f) a control facility including sufficient memory and processing capabilities for storing and processing said result records to define evidence of a pattern of compliance with said predetermined standards.

2. A system as in claim 1 wherein said predetermined standards comprise government regulatory requirements.

3. A system as recited in claim 2 wherein said predetermined standards further comprise owner regulatory requirements.

4. A system as recited in claim 2 wherein said predetermined standards further comprise owner regulatory requirements which exceed said government regulatory standards.

5. A system as recited in claim 1 further comprising a plurality of corrective actions communicated to the user on said display, each of said corrective actions being responsive to individual ones of said user responses which indicate the existence of conditions non-compliant with associated ones of said predetermined standards.

6. A system as recited in claim 5 wherein said corrective actions require supplemental user responses directed toward compliance of actual conditions of said operational categories with associated ones of said predetermined standards.

7. A system as recited in claim 1 wherein each of said tasks comprises at least one test item requiring said user response, each of said test items communicated to the user on said display.

8. A system as recited in claim 7 wherein each said test items are communicated to the user on said display concurrently with at least one related user response.

9. A system as recited in claim 8 wherein said input facilities are structured to provide user selection of at least said one related user response.

10. A system as recited in claim 9 wherein said input facilities comprise a probe assembly interfaced with said local processor assembly and structured to determine said one related user response.

11. A system as recited in claim 10 wherein said probe assembly comprises a temperature sensing probe structured to determine an existing temperature, said one related user response communicated on said display as said existing temperature.

12. A system as recited in claim 7 wherein each of said test items are communicated to the user on said display concurrently with a plurality of related user responses.

13. A system as recited in claim 12 wherein said input facilities are further structured to provide user selection of an appropriate one of said plurality of user responses indicative of actual operating conditions.

14. A system as recited in claim 13 wherein said input facilities comprise a display activated keypad structured to allow manual user selection of an appropriate one of said user responses.

15. A system as recited in claim 1 wherein said monitoring program includes a scheduling application including preferred performance of said plurality of inquisitory tasks at a specified time.

16. A system as recited in claim 15 wherein said scheduling application indicates preferred performance of said plurality of inquisitory tasks in a predetermined sequence.

17. A system as recited in claim 16 wherein said monitoring program further comprises an alert application for communicating untimely input of a corresponding user response to a scheduled inquisitory task.

18. A system as recited in claim 15 wherein said monitoring program further comprises an alert application for communicating untimely response to a scheduled task.

19. A system as recited in claim 1 wherein said input facilities comprise a temperature acquisition module interfaced with said local processor assembly and structured to determine an appropriate user response.

20. A system as recited in claim 10 wherein said temperature acquisition module comprises a probe assembly including a temperature sensing probe structured to determine an existing temperature and communicate the determined existing temperature to said display for communication to the user as a user response.

21. A system as recited in claim 20 wherein said input facilities comprise a display activated keypad structured to allow user selection of an appropriate one of a plurality of displayed user responses.

22. A system as recited in claim 1 wherein said input facilities comprise a display activated keypad structured to allow user selection of an appropriate one of said user responses displayed concurrently with a related inquisitory task.

23. A system as recited in claim 1 wherein said local processor assembly comprises a portable, handheld computer.

24. A system for monitoring at least one of a plurality of food service sites, said system comprising:
a) a portable processor operable at the site and comprising memory, a display and input facilities,
b) said portable processor assembly including a monitoring program determinative of compliant operational performance of the site,
c) said monitoring program comprising a task application relating to different operational categories,
d) said task application including a plurality of test items each requiring a user response indicative of actual conditions associated with said plurality of operational categories,
e) a plurality of predetermined standards defining acceptable performance parameters for said operational categories,
f) a corrective application comprising a plurality of corrective actions, each being responsive to a user response which is non-compliant with associated ones of said plurality of predetermined standards,
g) result records comprised of data derived from a collection of said user responses and indicative of compliance with said predetermined standards, and
h) a control facility including a central processor having sufficient capability to process said result records in a manner evidencing a pattern of compliance with said predetermined standards.

25. A system as recited in claim 24 wherein said input facilities comprise a temperature acquisition module interfaced with said portable processor and structured to communicate data defining user response and representative of actual conditions of said portable processor.

26. A system as recited in claim 25 wherein said temperature acquisition module comprises a probe assembly including a temperature sensing probe operative by the user to determine existing temperature data, said temperature data automatically communicated to the user on said display and defining a corresponding user response.

27. A system as recited in claim 26 wherein said plurality of input facilities further comprise a display activated keypad structured to allow user selection of an appropriate one of a plurality of user responses evident on said display.

28. A system as recited in claim 24 wherein each of said test items are communicated to the user on said display substantially concurrently with at least one user response appropriate to indicate an actual condition of a corresponding one of said operational categories.

29. A system as recited in claim 28 wherein at least some of said test items are concurrently displayed with a plurality of user responses individually appropriate to indicate actual conditions of a corresponding one of said operational categories.

30. A system as recited in claim 24 wherein said plurality of predetermined standards comprise government derived standards.

31. A system as recited in claim 30 wherein said plurality of predetermined standards comprise owner derived standards.

32. A system as recited in claim 31 wherein said owner derived standards exceed said government derived standards.

33. A system as recited in claim 24 wherein said plurality of corrective actions are communicated to the user on said display and require a user performed action.

34. A system as recited in claim 33 wherein said corrective application further comprises requirements for a supplementary user response indicative of compliance of actual conditions with related ones of said plurality of predetermined standards.

35. A system as recited in claim 24 wherein said monitoring program further comprises an alert application for communicating untimely user responses to said plurality of text items.

36. A process for monitoring operation of at least one of a plurality of food service sites, said process comprising: p1 a) establishing a plurality of categories associated with the functioning of the site,
b) determining a plurality of user interactive tasks relating to the operational categories and being indicative of a degree of performance thereof,
c) acknowledging a plurality of standards which define acceptable performance parameters for the operational categories,
d) requiring user responses to the tasks which are indicative of actual conditions associated with the plurality of operational categories,
e) collecting resulting records comprised of data derived from the user responses and being indicative of compliance with the predetermined standards, and
f) processing the result records to establish evidence of a pattern of compliance with said plurality of standards.

37. A process as recited in claim 36 comprising communicating a plurality of corrective actions to the user in response to entry of user responses indicative of existing conditions being non-compliant with the plurality of standards.

38. A process as recited in claim 37 comprising requesting performance of the corrective actions by the user in an attempt to bring existing conditions of the operational categories into compliance with the plurality of standards.

39. A process as recited in claim 38 requiring supplementary user response subsequent to performance of the corrective actions which are indicative of compliance of the existing conditions with the plurality of standards.

40. A process as recited in claim 36 comprising defining the plurality of user interactive tasks as a plurality of test items directing user performance to determine existing conditions associated with the plurality of operational categories.

41. A process as recited in claim 40 comprising providing the user with a plurality of user responses indicative of a plurality of possible existing conditions of the plurality of operational categories.

42. A process as recited in claim 41 comprising manually selecting at least one of the provided plurality of user responses.

43. A process as recited in claim 42 comprising automatically selecting at least one of the provided plurality of user responses.

44. A process as recited in claim 41 comprising defining requested user responses as temperature automatically determined by temperature sensing.

45. A process as recited in claim 44 comprising automatically recording the user responses defined by the sensed temperatures.

46. A process as recited in claim 40 comprising scheduling periodic performance of the plurality of test items and required user responses.

47. A process as recited in claim 46 comprising determining untimely entry of user responses to scheduled test items being indicative of untimely user performance of scheduled test items.

48. A process as recited in claim 36 comprising processing the result records to establish documentary evidence of a pattern of compliance with said plurality of standards.
